(19) United States
(12) Patent Application Publication
(10) Pub. No.: US 2024/0323507 A1
(43) Pub. Date: Sep. 26, 2024

(54) PANAMORPHIC LENS SYSTEM

(71) Applicant: Arriver Software AB, Linkoping (SE)

(72) Inventors: Per Agne KNUTSSON, Linkoping (SE); Olexiy KARDASH, Linkoping (SE)

(21) Appl. No.: 18/190,029

(22) Filed: Mar. 24, 2023

(51) Int. Cl. H04N 23/55; G02B 13/06; G02B 13/18; H04N 23/69

(52) U.S. Cl. CPC H04N 23/55; G02B 13/06; G02B 13/18; H04N 23/69

(57) ABSTRACT

Systems and techniques for providing a panamorphic lens system are disclosed. An optical detection process includes receiving light at a lens system comprising a plurality of optical elements aligned relative to an optical axis. The process can include receiving the light at an aspherical optical element configured to adjust a light path to produce an optical distortion characteristic for an image. The process can include receiving the light at first and a second cylindrical optical elements. The first and second cylindrical optical elements are configured to produce the image with a first magnification along a first image axis and a different second magnification along a second image axis orthogonal to the first image axis. The process can include receiving the image at an image sensor. The received image has the first magnification along the first image axis, the second magnification along the second image axis, and the optical distortion characteristic.

### FIELD OF THE DISCLOSURE

Aspects of the disclosure relate generally to optical lens systems. In some implementations, systems and techniques are described for providing a panamorphic lens system.

### BACKGROUND OF THE DISCLOSURE

Object detection and tracking can be used to identify an object (e.g., from a digital image or a video frame of a video clip) and track the object over time. Object detection and tracking can be used in different fields, including transportation, video analytics, security systems, robotics, aviation, among many others. In some fields, a tracking object can determine positions of other objects (e.g., target objects) in an environment so that the tracking object can accurately navigate through the environment. In order to make accurate motion and trajectory planning decisions, the tracking object may also have the ability to estimate various target object characteristics, such as pose (e.g., including position and orientation) and size.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for implementing a panamorphic lens system.

According to at least one example, a method is provided for optical detection. The method includes: receiving light at a lens system comprising a plurality of optical elements, wherein the plurality of optical elements are aligned relative to an optical axis; receiving the light at an aspherical optical element of the lens system configured to adjust a light path of the light through the lens system to produce an optical distortion characteristic for an image produced by the light passing through the lens system; receiving the light at a first cylindrical optical element; receiving the light at a second cylindrical optical element, wherein the first cylindrical optical element and the second cylindrical optical element are configured to produce the image with a first magnification along a first image axis and a second magnification along a second image axis orthogonal to the first image axis, and wherein the first magnification is different from the second magnification; and receiving the image at an image sensor, wherein the received image has the first magnification along the first image axis, the second magnification along the second image axis, and the optical distortion characteristic.

In another example, an apparatus for providing optical detection is provided that includes at least one memory and at least one processor coupled to the at least one memory. The at least one processor is configured to: receive light at a lens system comprising a plurality of optical elements, wherein the plurality of optical elements are aligned relative to an optical axis; receive the light at an aspherical optical element of the lens system configured to adjust a light path of the light through the lens system to produce an optical distortion characteristic for an image produced by the light passing through the lens system; receive the light at a first cylindrical optical element; receive the light at a second cylindrical optical element, wherein the first cylindrical optical element and the second cylindrical optical element are configured to produce the image with a first magnification along a first image axis and a second magnification along a second image axis orthogonal to the first image axis, and wherein the first magnification is different from the second magnification; and receive the image at an image sensor, wherein the received image has the first magnification along the first image axis, the second magnification along the second image axis, and the optical distortion characteristic.

In another example, a non-transitory computer-readable medium is provided that has stored thereon instructions that, when executed by one or more processors, cause the one or more processors to: receive light at a lens system comprising a plurality of optical elements, wherein the plurality of optical elements are aligned relative to an optical axis; receive the light at an aspherical optical element of the lens system configured to adjust a light path of the light through the lens system to produce an optical distortion characteristic for an image produced by the light passing through the lens system; receive the light at a first cylindrical optical element; receive the light at a second cylindrical optical element, wherein the first cylindrical optical element and the second cylindrical optical element are configured to produce the image with a first magnification along a first image axis and a second magnification along a second image axis orthogonal to the first image axis, and wherein the first magnification is different from the second magnification; and receive the image at an image sensor, wherein the received image has the first magnification along the first image axis, the second magnification along the second image axis, and the optical distortion characteristic.

In some aspects, one or more of the apparatuses described herein is, is part of, or includes a vehicle or a computing device or system of a vehicle, a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, or other device. In some aspects, an apparatus includes a camera or multiple cameras for capturing one or more images. In some aspects, the apparatus includes a display for displaying one or more images, notifications, and/or other displayable data. In some aspects, the apparatus can include one or more sensors. In some cases, the one or more sensors can be used for determining a location and/or pose of the apparatus, a state of the apparatuses, and/or for other purposes.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 is an image illustrating multiple vehicles driving on a road, in accordance with some examples of the present disclosure;

FIG. 2 is a block diagram illustrating an example of a vehicle computing system, in accordance with some examples of the present disclosure;

FIG. 3 is a block diagram illustrating an architecture of an image capture and processing device, in accordance with some examples of the present disclosure;

FIG. 4A is a diagram illustrating an example multi-camera image system, in accordance with some examples of the present disclosure;

FIG. 4B is a diagram illustrating an additional example multi-camera image system, in accordance with some examples of the present disclosure;

FIG. 5A illustrates a distorted raw image of a scene, in accordance with some examples of the present disclosure;

FIG. 5B through FIG. 5E illustrate example projections of the raw image of FIG. 5A, in accordance with some examples of the present disclosure;

FIG. 6A and FIG. 6B illustrate an example image of horizontal resolution limitations in different portions of an environment, in accordance with some examples of the present disclosure;

FIG. 7A and FIG. 7B illustrate an example lens system, in accordance with some examples of the present disclosure;

FIG. 8 illustrates an example lens holder for the lens system of FIG. 7A and FIG. 7B, in accordance with some examples of the present disclosure;

FIG. 9A and FIG. 9B illustrate a relationship between an object space and an image space for a simulated lens system, in accordance with some examples of the present disclosure;

FIG. 10 is a flowchart illustrating an example of a process for performing object detection using the techniques described herein, in accordance with some examples of the present disclosure;

FIG. 11 is a block diagram of an exemplary computing device that may be used to implement some aspects of the technology described herein, in accordance with some examples of the present disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes can be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Object detection and tracking can be used in driving systems, video analytics, security systems, robotics systems, aviation systems, extended reality (XR) systems (e.g., augmented reality (AR) systems, virtual reality (VR) systems, mixed reality (MR) systems, etc.), among other systems. In such systems, an object (referred to as a tracking object) tracking other objects (referred to as target objects) in an environment can determine positions and/or sizes of the other objects. Determining the positions and/or sizes of target objects in the environment allows the tracking object to accurately navigate the environment by making intelligent motion planning and trajectory planning decisions.

Increasingly, systems and devices (e.g., autonomous vehicles, such as autonomous and semi-autonomous cars, drones, mobile robots, mobile devices, extended reality (XR) devices, and other suitable systems or devices) include multiple sensors to gather information about the environment, as well as processing systems to process the information gathered, such as for route planning. navigation, collision avoidance, etc. One example of such a system is an Advanced Driver Assistance System (ADAS) for a vehicle. Sensor data, such as images captured from one or more cameras, may be gathered, transformed, and analyzed to detect objects (e.g., targets). Detected objects may be compared to objects indicated on a high-definition (HD) map for localization of the vehicle. Localization may help a vehicle or device determine where on a road the vehicle is travelling.

In some approaches, a detection and tracking system of a tracking object (e.g., a tracking vehicle) can receive or obtain images containing a target object (e.g., a road). Some detection and tracking systems may also generate three-dimensional (3D) models of the environment surrounding the tracking object, including a 3D point map of a road (or other surface) In some cases, features of the road such as lane markings (e.g., lane lines) can be represented as individual points in the 3D point map of the environment surrounding the tracking object. A point map registration system can perform a registration between point maps generated based on images captured by the object tracking and detection system a reference point map representation. In some cases, accurate registration can provide a better understanding of the position of the tracking object relative to the road (e.g., lane position, location of other vehicles). In some implementations, the systems and techniques described herein can be used for accurate real-time vehicle position tracking.

In some cases, semantic information can be used to improve registration between point maps. For example, in the case the wheels of a vehicle driving on a road (or on another surface), a registration system can leverage semantic information about the road to improve registration. For example, points in the point maps corresponding to objects (e.g., vehicles, barriers, traffic signs, lane lines) can be grouped together in groups corresponding to the objects. For example, points in a point map can be grouped together as lines based on distances between adjacent points.

Many devices and systems include optical elements, which can include lenses for focusing light onto an image sensor. In one example, a camera or a device including a camera (e.g., a vehicle camera system, a mobile device, an XR device, etc.) with optical elements can capture an image or a sequence of images of a scene (e.g., a video of a scene). In order to achieve desirable optical characteristics (e.g., sharpness, wide field of view (FOV), etc.), the camera or camera device can utilize refractive lenses to focus incoming light on an image sensor. In some cases, a lens system for a camera device can include compound lens comprising multiple refractive lens elements stacked together.

In some applications, a camera system can include multiple cameras (referred to herein as a multiple camera system). In some cases, the multiple cameras can collectively capture images with a 360-degree FOV. As used herein, images captured by individual cameras of a multiple camera system may be referred to as images of a scene. In addition, as used herein, a combination of scenes (or portions thereof) captured by the multiple cameras of a multiple camera system may be referred to as an environment. In one illustrative example, an automotive camera system can include multiple cameras facing in different directions. For example, a multiple camera system may include one or more forward facing cameras, one or more rear facing cameras, and one or more side-facing cameras. In one illustrative example, a multiple camera system may include a wide FOV forward camera, a narrow FOV forward camera, an ultra-wide FOV forward camera, forward looking side cameras, rear looking side cameras, and a rear camera.

In some cases, the horizontal FOV of interest for a particular scene (e.g., a portion of the environment) captured by the multiple camera system can be significantly greater than the vertical FOV of interest. In one illustrative example, a vertical FOV of 50 degrees and a horizontal FOV of 180 degrees may be used for providing sufficient viewing angles to capture a view of one side of a vehicle. In such an example, the ratio of horizontal FOV/vertical FOV is equal to 3.6:1.

In some cases, a ratio between the horizontal FOV and vertical FOV captured by a camera can be limited by the shape and/or size of an image sensor included in the camera. For example, in some examples, image sensor aspect ratios can range between approximately 2:1 and approximately 4:3. For example, aspect ratios between approximately 2:1 and approximately 4:3 are commonly used in image sensors produced for photography, video, or the like. In some aspects, it can be advantageous to incorporate image sensors with commonly used aspect ratios in a multiple camera system due to cost, availability, or the like. However, in some cases, a multiple camera system may utilize two cameras to successfully capture a scene with a horizontal FOV/vertical FOV ratio (also referred to as an H/V FOV ratio) greater than the aspect ratio of a single image sensor. In some cases, increasing the number of cameras in a multiple camera system can increase power consumption, and/or can require additional computation resources such as increased system bandwidth requirements, increased number of computations (e.g., MIPS), and/or increased memory usage. In some cases, a camera may utilize an image sensor with an aspect ratio greater than 2:1 to increase the H/V FOV ratio. However, such non-standard image sensors may require custom design and fabrication, which can result in increased costs, low availability of parts, or the like.

In some cases, the horizontal FOV of a camera system can be extended by providing a lens system for a side facing camera (or multiple side facing cameras) that can produce a wide FOV image (e.g., a wide-angle lens system). However, in some cases, wide angle lens systems can distort images of the scene in one or more ways. Example types of distortion can include f-theta distortion and/or radial distortion, such as barrel distortion, pincushion distortion, or mustache distortion. In addition, in some cases, the distortion can result in obscuring portions of the scene captured in the images (e.g., obscured by a portion of a lens holder), altering the appearance of the scene and objects in the scene captured in the image (e.g., warping, stretching, twisting, etc.), or the like.

In some cases, image pre-processing (e.g., in the form of digital image manipulation) can be used to perform software-based distortion compensation. In one illustrative example, warping the distorted image with a projection technique (e.g., stereographic projection, equidistant projection, equirectangular projection, cylindrical projection, or the like) can compensate for the distortion. However, software-based compensation for distortion can be difficult and computationally expensive to perform. Moreover, software-based compensation can, in some cases, rely on approximations and/or models that may not be applicable in all cases, and can end up warping the image inaccurately or incompletely. In some aspects, the resulting image with the compensation applied may still retain some distortion, may end up distorted in an different manner to the original image due to incorrect and/or incomplete distortion compensation, and/or may include other visual artifacts (e.g., local loss of resolution).

Systems and techniques are needed for providing cameras with a high H/V FOV ratio while minimizing impacts to system performance, cost, complexity, and/or availability. For example, it would be advantageous to provide a camera system that can provide an H/V FOV ratio greater than 3:1 utilizing a single image sensor with an aspect ratio between 4:3 and 2:1. In some aspects, it would be advantageous for a camera system to produce images with a desired optical distortion characteristic without the need for software based image pre-processing. It would also be advantageous for the camera system with a high H/V FOV ratio to provide minimal system performance degradation relative to existing approaches (e.g., multiple cameras, wide-angle lenses, or the like).

Systems, apparatuses, processes (methods), and computer-readable media (collectively referred to as “systems and techniques”) are described herein that provide solutions to provide cameras with a high H/V FOV ratio. In some examples, the systems and techniques include implementing a panoramic and anamorphic (panamorphic) lens system to produce an image with a high H/V FOV ratio. In some examples, the lens system can be included in one or more cameras of a multiple camera system. In some cases, the systems and techniques can be used in side facing cameras of an automotive camera system to provide approximately 180 degree horizontal FOV utilizing a single camera. In some cases, the single camera can include an image sensor that has an aspect ratio between 4:3 and 2:1.

In some examples, the systems and techniques described herein can increase the H/V FOV ratio of a camera system by optically compressing (e.g., magnifying) the scene along a horizontal image axis. For example, in some cases, a first axis (e.g., a horizontal image axis) can have a greater magnification than a second axis (e.g., a vertical axis). In some cases, decreased magnification in the horizontal image axis can compress the resulting image captured by an image sensor in the horizontal direction. In some cases, optical elements can be included in a lens system to produce different magnification along different axes. In some cases, the horizontal resolution of objects in the scene can be reduced by the magnification factor along the horizontal image axis., thereby reducing the width of the resulting image in the horizontal image axis. In some cases, the aspect ratio of the resulting image can be reduced such that a single camera can capture the full extent of the horizontal and vertical FOV of a scene. In some cases, the horizontal image axis magnification can compress the resulting image along the horizontal field of view. In some aspects, compressing an image can result in degraded performance for one or more systems that process images captured by the multiple camera system (e.g., an object detection and/or tracking system).

However, in some examples, one or more cameras in a multiple camera system may have horizontal resolution limitations due to one or more other factors. In some examples, compressing images of the scene according to the systems and techniques described herein can be achieved without significantly degrading performance of one or more systems that process the compressed images. For example, horizontal resolution may be limited by motion blur, minimum exposure time for capturing images in low-light conditions, or the like. In one illustrative example, the horizontal resolution of a side facing camera can be compressed without significantly degrading system performance (e.g., for a vehicular object detection and tracking system). For example, in some cases, motion blur for objects at large angles relative to a direction of motion (e.g., in a vehicular multiple camera system) can be larger than motion blur for objects at smaller angles relative to the direction of motion. In one illustrative example, images captured by side facing cameras will likely capture more motion blur than front facing cameras.

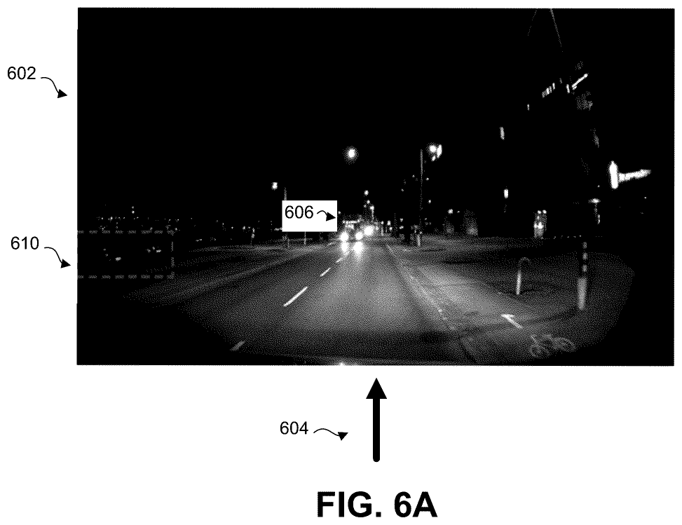

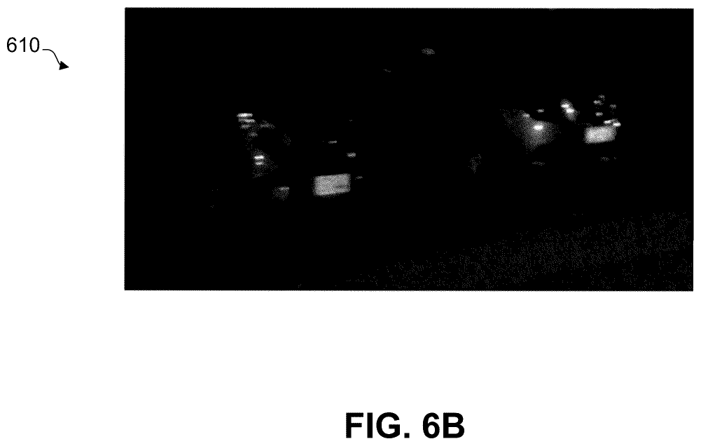

FIG. 6A and FIG. 6B illustrate an example image 602 that demonstrates example of portions of an environment that may have different horizontal resolution limitations. In the illustrated example of FIG. 6A, the image can represent an image captured by a wide angle front facing camera of a vehicular multiple camera system. As illustrated in FIG. 6A, arrow 604 represents a direction of motion of a tracking vehicle. In the example image, a bus 606 is positioned close to the center of the image 602 and in a relatively well illuminated portion of the environment. The bus may be moving almost directly toward the camera capturing the image 602, and as a result may experience relatively little motion blur. In some cases, the portion of the environment occupied by the bus may have a horizontal resolution limit that is limited by the optics of a lens of the wide angle front facing camera used to capture image 602. By contrast, portion 610 of the environment captured in image 602 is located close to an edge of the image 602 (e.g., at a horizontal viewing angle approximately 45 degrees) and the environment in portion 610 is poorly illuminated. FIG. 6B illustrates a zoomed-in view of the portion 610. As illustrated, the horizontal resolution of portion 610 may be limited by the motion blur and/or a minimum exposure time. In some examples, optical compression along the horizontal axis may be used with little or no impact on the horizontal resolution of a captured image.

In one illustrative example, the systems and techniques can include a lens system that includes a pair of cylindrical optical elements that can produce the different magnifications along a first axis (e.g., the horizontal axis) and a second axis (e.g., the vertical image axis). In some cases, a first cylindrical optical element can provide magnification along the first axis without providing magnification along the second axis. In some cases, a single cylindrical optical element may not be able to provide a focused image along both the first and second axis. In some cases, a second cylindrical optical element can focus the light passing through the first cylindrical optical element. In some examples, at least one of the first or second optical elements can contribute to the total magnification along the first axis.

In some cases, the systems and techniques described herein can reduce or eliminate the need for computationally expensive image pre-processing due to optical distortion. For example, in some implementations, an aspherical optical element (e.g., an aspherical lens) can compensate for distortion introduced by other optical elements (e.g., the pair of cylindrical optical elements) in the lens system. In some cases, the aspherical optical element can be configured to provide a desired optical distortion characteristic for the lens system. Example desired optical distortion characteristics can include, without limitation, cylindrical projection, equidistant projection, equirectangular projection, or the like.

In some cases, the optical elements of a lens system according to the systems and techniques described herein (e.g., including two cylindrical lenses and/or an aspherical optical element) may reduce the amount of light captured by an image sensor relative to existing systems. In some cases, an aperture for a lens system according to the systems and techniques described herein (e.g., including two cylindrical lenses and an aspherical optical element) may be designed to increase the amount of light available at the image sensor after passing through the lens system to compensate for the loss. For example, the aperture can be circular but oversized relative to a similar lens solution lacking cylindrical optical elements. In another illustrative example, an elliptical aperture can be used with a horizontal diameter (e.g., along the horizontal image axis) than is larger than the vertical diameter (e.g., along the vertical image axis).

In some cases, a camera utilizing a lens system according to the systems and techniques described herein can be particularly sensitive to the orientation of the lens system relative to an image sensor. For example, if the horizontal axis of the lens system is not aligned with the image sensor, the resulting images may be compressed, cropped, or otherwise degraded. In some cases, an alignment system may be used to align the axes of the lens with the axes of an image sensor. In one example, the lens system can be included in a unibody lens holder. In some examples, external mechanical features (e.g., a keying system) can be positioned relative to the alignment of the lens system axes. In some cases, the keying system can be used to ensure proper alignment of the lens system and the image sensor by mating the lens holder to a corresponding mating part. For example, the external mechanical features can be used when assembling rotationally sensitive components of a camera (e.g., by mounting the lens holder to a camera body or image sensor mount) to assure proper orientation between the lens system and the image sensor. In some cases, the mechanical features can be configured to provide a mechanical reference relative to the horizontal and vertical axes of the image sensor.

Examples are described herein using vehicles as illustrative examples of tracking objects and vehicles as illustrative examples of target objects. However, one of ordinary skill will appreciate the systems and related techniques described herein can be included in and performed by any other system or device for detecting and/or tracking any type of objects in one or more images. Examples of other systems that can perform or that can include components for performing the techniques described herein include robotics systems, extended reality (XR) systems (e.g., augmented reality (AR) systems, virtual reality (VR) systems, mixed reality (MR) systems, etc.), video analytics, security systems, aviation systems, among others systems. Examples of other types of objects that can be detected include people or pedestrians, infrastructure (e.g., roads, signs, etc.), among others. In one illustrative example, a tracking vehicle can perform one or more of the techniques described herein to detect a pedestrian or infrastructure object (e.g., a road sign) in one or more images.

The systems and techniques described herein provide advantages over existing camera systems. For example, the systems and techniques can be used to achieve a horizontal FOV (e.g., approximately 180 degrees) using a single side facing camera while maintaining a desired vertical FOV without compression of the vertical FOV. In some cases, the systems and techniques described herein can provide the desired horizontal FOV commonly available image sensors having an aspect ratio between approximately 4:3 and approximately 2:1. For example, the systems and techniques described herein can optically compress (e.g., magnify) the horizontal axis of an image to achieve a H/V FOV ratio greater than the aspect ratio of the image sensor. In another example, a lens system according to the systems and techniques described herein can produce images with a more desirable distortion characteristic than existing lens solutions (e.g., fish-eye lenses, wide-angle lenses) that may be utilized to extend the horizontal FOV of captured images. In some cases, the systems and techniques can provide the advantages described herein without significantly degrading performance of systems that perform functions based on processing images (e.g., a vehicular multiple camera system). For example, horizontal axis resolution requirements for one or more side facing cameras may be low due to motion blur, minimum exposure requirements, signal to noise ratio, or the like. In some examples, the horizontal axis compression provided by the systems and techniques herein can be processed to provide similar and/or equal performance to existing systems for functions based on processing images.

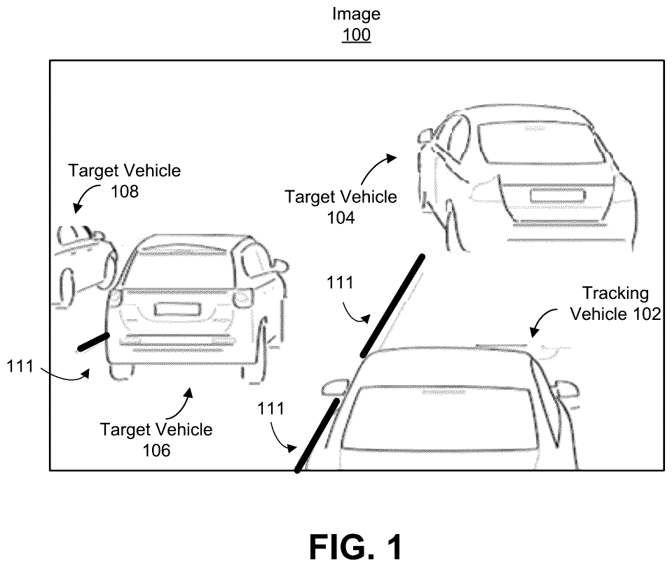

Various aspects of the application will be described with respect to the figures. FIG. 1 is an image 100 illustrating an environment including numerous vehicles driving on a road. The vehicles include a tracking vehicle 102 (as an example of a tracking object), a target vehicle 104, a target vehicle 106, and a target vehicle 108 (e.g., as examples of tracking object). The tracking vehicle 102 can track the target vehicles 104. 106, and 108 and/or lane lines 111 in order to navigate the environment. For example, the tracking vehicle 102 can determine the position of the tracking vehicle 102 to determine when to slow down, speed up, change lanes, and/or perform some other function. While the vehicle 102 is referred to as a tracking vehicle 102 and the vehicles 104, 106, and 108 are referred to as target vehicles with respect to FIG. 1, the vehicles 104. 106, and 108 can also be referred to as tracking vehicles if and when they are tracking other vehicles, in which case the other vehicles become target vehicles.

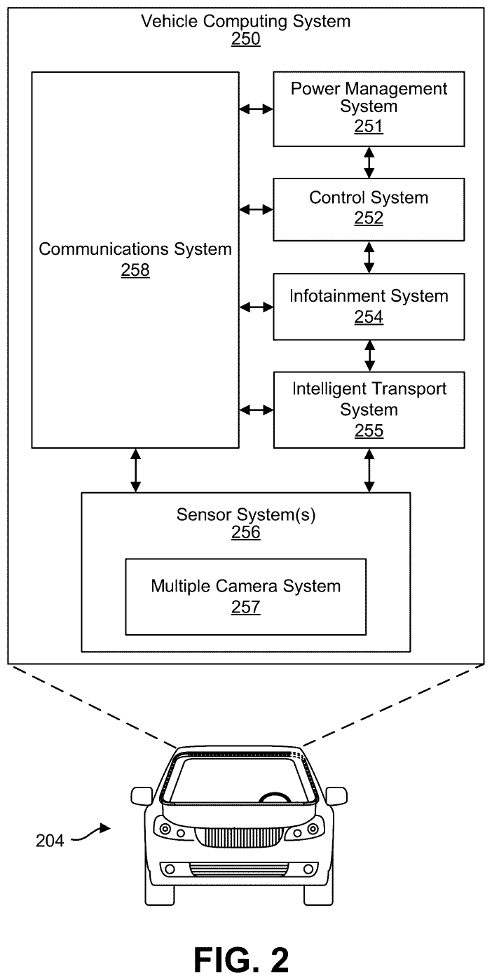

FIG. 2 is a block diagram illustrating an example a vehicle computing system 250 of a vehicle 204. The vehicle 204 is an example of a user equipment (UE) that can communicate with a network (e.g., an eNodeB, a gNodeB, a positioning beacon, a location measurement unit, and/or other network entity) over a network interface (e.g., a Uu interface) and with other UEs using vehicle to everything (V2X) communications over a device-to-device direct interface. As shown, the vehicle computing system 250 can include at least a power management system 251, a control system 252, an infotainment system 254, an intelligent transport system (ITS) 255, one or more sensor systems 256, and a communications system 258. In some cases, the vehicle computing system 250 can include or can be implemented using any type of processing device or system, such as one or more central processing units (CPUs), digital signal processors (DSPs), application specific integrated circuits (ASICs), field programmable gate arrays (FPGAs), application processors (APs), graphics processing units (GPUs), vision processing units (VPUs), Neural Network Signal Processors (NSPs), microcontrollers, dedicated hardware, any combination thereof, and/or other processing device or system.

The control system 252 can be configured to control one or more operations of the vehicle 204, the power management system 251, the computing system 250, the infotainment system 254, the ITS 255, and/or one or more other systems of the vehicle 204 (e.g., a braking system, a steering system, a safety system other than the ITS 255, a cabin system, and/or other system). In some examples, the control system 252 can include one or more electronic control units (ECUs). An ECU can control one or more of the electrical systems or subsystems in a vehicle. Examples of specific ECUs that can be included as part of the control system 252 include an engine control module (ECM), a powertrain control module (PCM), a transmission control module (TCM), a brake control module (BCM), a central control module (CCM), a central timing module (CTM), among others. In some cases, the control system 252 can receive sensor signals from the one or more sensor systems 256 and can communicate with other systems of the vehicle computing system 250 to operate the vehicle 204.

The vehicle computing system 250 also includes a power management system 251. In some implementations, the power management system 251 can include a power management integrated circuit (PMIC), a standby battery, and/or other components. In some cases, other systems of the vehicle computing system 250 can include one or more PMICs, batteries, and/or other components. The power management system 251 can perform power management functions for the vehicle 204, such as managing a power supply for the computing system 250 and/or other parts of the vehicle. For example, the power management system 251 can provide a stable power supply in view of power fluctuations, such as based on starting an engine of the vehicle. In another example, the power management system 251 can perform thermal monitoring operations, such as by checking ambient and/or transistor junction temperatures. In another example, the power management system 251 can perform certain functions based on detecting a certain temperature level, such as causing a cooling system (e.g., one or more fans, an air conditioning system, etc.) to cool certain components of the vehicle computing system 250 (e.g., the control system 252, such as one or more ECUs), shutting down certain functionalities of the vehicle computing system 250 (e.g., limiting the infotainment system 254, such as by shutting off one or more displays, disconnecting from a wireless network, etc.), among other functions.

The vehicle computing system 250 further includes a communications system 258. The communications system 258 can include both software and hardware components for transmitting signals to and receiving signals from a network (e.g., a gNB or other network entity over a Uu interface) and/or from other UEs (e.g., to another vehicle or UE over a PC5 interface, WiFi interface, Bluetooth™ interface, and/or other wireless and/or wired interface). For example, the communications system 258 is configured to transmit and receive information wirelessly over any suitable wireless network (e.g., a 3G network, 4G network, 5G network, WiFi network, Bluetooth™ network, and/or other network). The communications system 258 includes various components or devices used to perform the wireless communication functionalities.

In some cases, the communications system 258 can further include one or more wireless interfaces (e.g., including one or more transceivers and one or more baseband processors for each wireless interface) for transmitting and receiving wireless communications, one or more wired interfaces (e.g., a serial interface such as a universal serial bus (USB) input, a lightening connector, and/or other wired interface) for performing communications over one or more hardwired connections, and/or other components that can allow the vehicle 204 to communicate with a network and/or other UEs.

The vehicle computing system 250 can also include an infotainment system 254 that can control content and one or more output devices of the vehicle 204 that can be used to output the content. The infotainment system 254 can also be referred to as an in-vehicle infotainment (IVI) system or an In-car entertainment (ICE) system. The content can include navigation content, media content (e.g., video content, music or other audio content, and/or other media content), among other content. The one or more output devices can include one or more graphical user interfaces, one or more displays, one or more speakers, one or more extended reality devices (e.g., a VR, AR, and/or MR headset), one or more haptic feedback devices (e.g., one or more devices configured to vibrate a seat, steering wheel, and/or other part of the vehicle 204), and/or other output device.

In some examples, the vehicle computing system 250 can include the intelligent transport system (ITS) 255. In some examples, the ITS 255 can be used for implementing V2X communications. For example, an ITS stack of the ITS 255 can generate V2X messages based on information from an application layer of the ITS. In some cases, the application layer can determine whether certain conditions have been met for generating messages for use by the ITS 255 and/or for generating messages that are to be sent to other vehicles (for V2V communications), to pedestrian UEs (for V2P communications), and/or to infrastructure systems (for V2I communications). In some cases, the communications system 258 and/or the ITS 255 can obtain car access network (CAN) information (e.g., from other components of the vehicle via a CAN bus). In some examples, the communications system 258 (e.g., a TCU NAD) can obtain the CAN information via the CAN bus and can send the CAN information to the ITS stack. The CAN information can include vehicle related information, such as a heading of the vehicle, speed of the vehicle, breaking information, among other information. The CAN information can be continuously or periodically (e.g., every 1 millisecond (ms), every 10 ms, or the like) provided to the ITS 255.

The conditions used to determine whether to generate messages can be determined using the CAN information based on safety-related applications and/or other applications, including applications related to road safety, traffic efficiency, infotainment, business, and/or other applications. In one illustrative example, ITS 255 can perform lane change assistance or negotiation. For instance, using the CAN information, the ITS 255 can determine that a driver of the vehicle 204 is attempting to change lanes from a current lane to an adjacent lane (e.g., based on a blinker being activated, based on the user veering or steering into an adjacent lane, etc.). Based on determining the vehicle 204 is attempting to change lanes, the ITS 255 can determine a lane-change condition has been met that is associated with a message to be sent to other vehicles that are nearby the vehicle in the adjacent lane. The ITS 255 can trigger the ITS stack to generate one or more messages for transmission to the other vehicles, which can be used to negotiate a lane change with the other vehicles. Other examples of applications include forward collision warning, automatic emergency breaking, lane departure warning, pedestrian avoidance or protection (e.g., when a pedestrian is detected near the vehicle 204, such as based on V2P communications with a UE of the user), traffic sign recognition, among others.

The ITS 255 can use any suitable protocol to generate messages (e.g., V2X messages). Examples of protocols that can be used by the ITS 255 include one or more Society of Automotive Engineering (SAE) standards, such as SAE J2735, SAE J2945, SAE J3161, and/or other standards, which are hereby incorporated by reference in their entirety and for all purposes.

A security layer of the ITS 255 can be used to securely sign messages from the ITS stack that are sent to and verified by other UEs configured for V2X communications, such as other vehicles, pedestrian UEs, and/or infrastructure systems. The security layer can also verify messages received from such other UEs. In some implementations, the signing and verification processes can be based on a security context of the vehicle. In some examples, the security context may include one or more encryption-decryption algorithms, a public and/or private key used to generate a signature using an encryption-decryption algorithm, and/or other information. For example, each ITS message generated by the ITS stack can be signed by the security layer. The signature can be derived using a public key and an encryption-decryption algorithm. A vehicle, pedestrian UE, and/or infrastructure system receiving a signed message can verify the signature to make sure the message is from an authorized vehicle. In some examples, the one or more encryption-decryption algorithms can include one or more symmetric encryption algorithms (e.g., advanced encryption standard (AES), data encryption standard (DES), and/or other symmetric encryption algorithm), one or more asymmetric encryption algorithms using public and private keys (e.g., Rivest-Shamir-Adleman (RSA) and/or other asymmetric encryption algorithm), and/or other encryption-decryption algorithm.

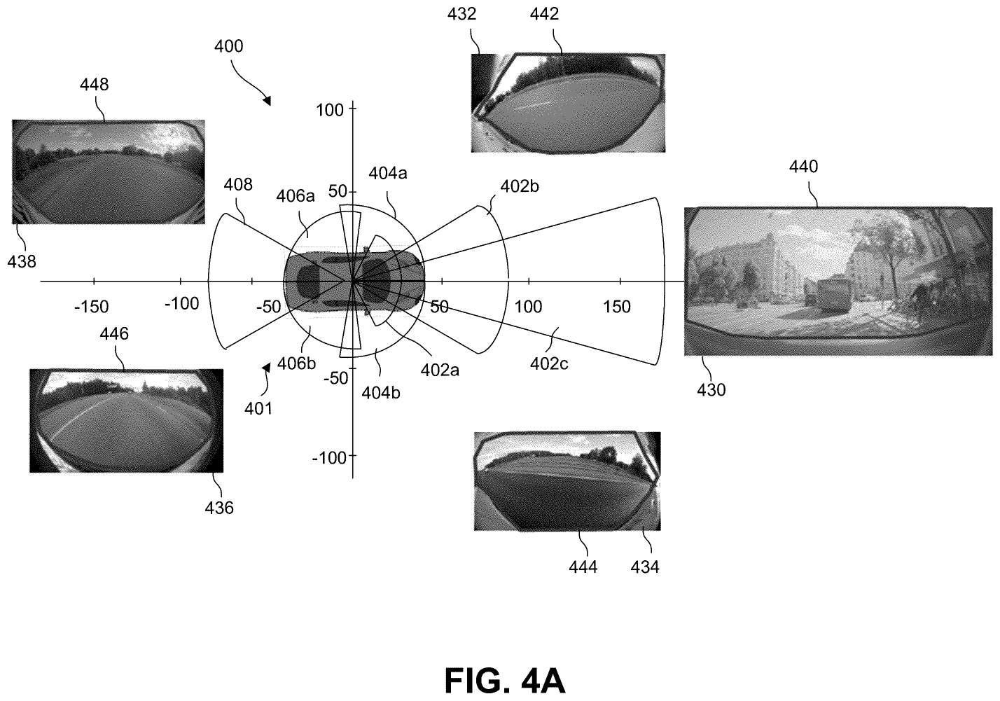

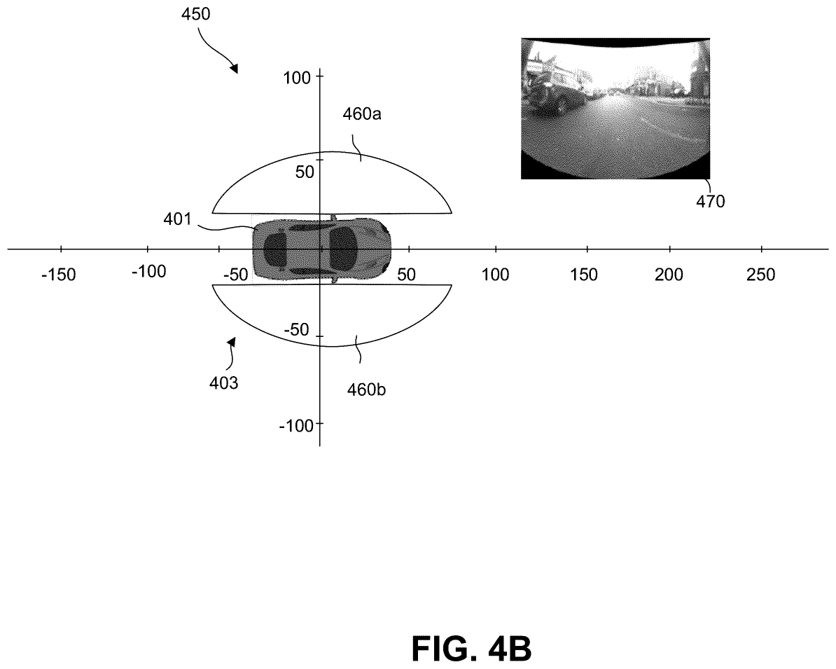

The computing system 250 further includes one or more sensor systems 256 (e.g., a first sensor system through an Nth sensor system, where N is a value equal to or greater than 0). When including multiple sensor systems, the sensor system(s) 256 can include different types of sensor systems that can be arranged on or in different parts the vehicle 204. The sensor system(s) 256 can include one or more camera sensor systems. In one illustrative example, the one or more camera sensor systems can be included in a multiple camera system 257 (e.g., multiple camera system 400 of FIG. 4A, multiple camera system 450 of FIG. 4B).

The sensor system(s) 256 can also include one or more Light Detection and Ranging (LIDAR) sensor systems, radio detection and ranging (RADAR) sensor systems, Electromagnetic Detection and Ranging (EmDAR) sensor systems, Sound Navigation and Ranging (SONAR) sensor systems, Sound Detection and Ranging (SODAR) sensor systems, Global Navigation Satellite System (GNSS) receiver systems (e.g., one or more Global Positioning System (GPS) receiver systems), accelerometers, gyroscopes, inertial measurement units (IMUs), infrared sensor systems, laser rangefinder systems, ultrasonic sensor systems, infrasonic sensor systems, microphones, any combination thereof, and/or other sensor systems. It should be understood that any number of sensors or sensor systems can be included as part of the computing system 250 of the vehicle 204.

While the vehicle computing system 250 is shown to include certain components and/or systems, one of ordinary skill will appreciate that the vehicle computing system 250 can include more or fewer components than those shown in FIG. 2. For example, the vehicle computing system 250 can also include one or more input devices and one or more output devices (not shown). In some implementations, the vehicle computing system 250 can also include (e.g., as part of or separate from the control system 252, the infotainment system 254, the communications system 258, and/or the sensor system(s) 256) at least one processor and at least one memory having computer-executable instructions that are executed by the at least one processor. The at least one processor is in communication with and/or electrically connected to (referred to as being “coupled to” or “communicatively coupled”) the at least one memory. The at least one processor can include, for example, one or more microcontrollers, one or more central processing units (CPUs), one or more field programmable gate arrays (FPGAs), one or more graphics processing units (GPUs), one or more application processors (e.g., for running or executing one or more software applications), and/or other processors. The at least one memory can include, for example, read-only memory (ROM), random access memory (RAM) (e.g., static RAM (SRAM)), electrically erasable programmable read-only memory (EEPROM), flash memory, one or more buffers, one or more databases, and/or other memory. The computer-executable instructions stored in or on the at least memory can be executed to perform one or more of the functions or operations described herein.

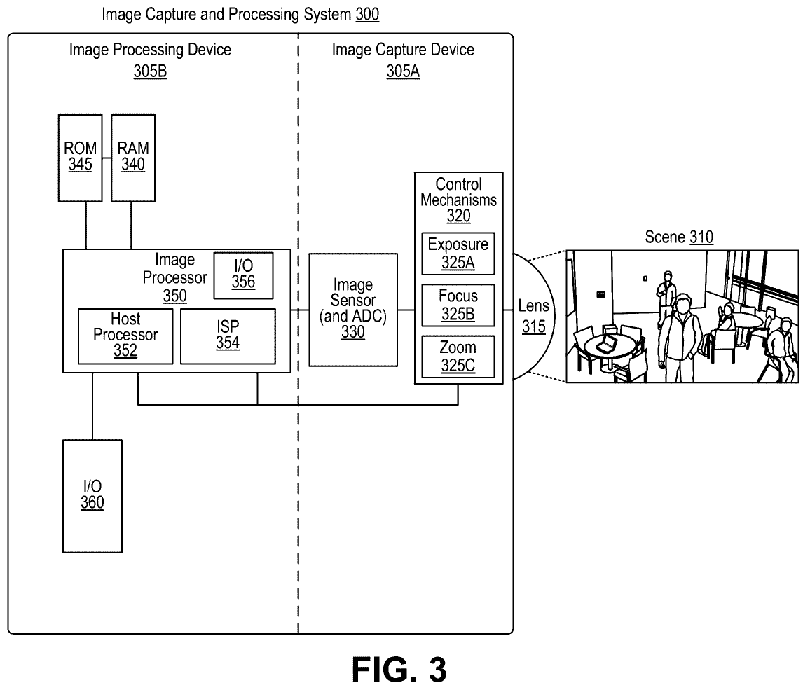

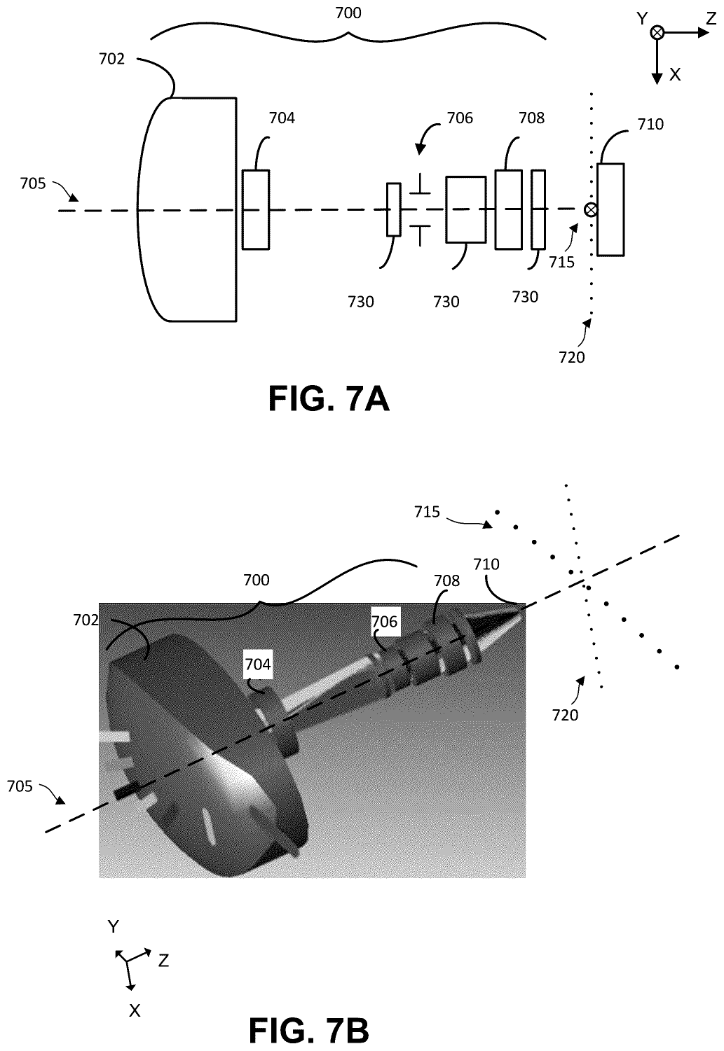

FIG. 3 is a block diagram illustrating an architecture of an image capture and processing system 300. The image capture and processing system 300 includes various components that are used to capture and process images of scenes (e.g., an image of a scene 310). The image capture and processing system 300 can capture standalone images (or photographs) and/or can capture videos that include multiple images (or video frames) in a particular sequence. In some cases, the lens 315 and image sensor 330 can be associated with an optical axis. In one illustrative example, the photosensitive area of the image sensor 330 (e.g., the photodiodes) and the lens 315 can both be centered on the optical axis. A lens 315 of the image capture and processing system 300 faces a scene 310 and receives light from the scene 310. The lens 315 bends incoming light from the scene toward the image sensor 330. The light received by the lens 315 passes through an aperture. In some cases, the aperture (e.g., the aperture size) is controlled by one or more control mechanisms 320 and is received by an image sensor 330. In some cases, the aperture can have a fixed size. In some cases, the lens 315 can correspond to a lens system (e.g., lens system 700 of FIG. 7A and FIG. 7B).

The one or more control mechanisms 320 may control exposure, focus, and/or zoom based on information from the image sensor 330 and/or based on information from the image processor 350. The one or more control mechanisms 320 may include multiple mechanisms and components; for instance, the control mechanisms 320 may include one or more exposure control mechanisms 325A, one or more focus control mechanisms 325B, and/or one or more zoom control mechanisms 325C. The one or more control mechanisms 320 may also include additional control mechanisms besides those that are illustrated, such as control mechanisms controlling analog gain, flash, HDR, depth of field, and/or other image capture properties.

The focus control mechanism 325B of the control mechanisms 320 can obtain a focus setting. In some examples, focus control mechanism 325B store the focus setting in a memory register. Based on the focus setting, the focus control mechanism 325B can adjust the position of the lens 315 relative to the position of the image sensor 330. For example, based on the focus setting, the focus control mechanism 325B can move the lens 315 closer to the image sensor 330 or farther from the image sensor 330 by actuating a motor or servo (or other lens mechanism), thereby adjusting focus. In some cases, additional lenses may be included in the image capture and processing system 300, such as one or more microlenses over each photodiode of the image sensor 330, which each bend the light received from the lens 315 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 320, the image sensor 330, and/or the image processor 350. The focus setting may be referred to as an image capture setting and/or an image processing setting. In some cases, the lens 315 can be fixed relative to the image sensor and focus control mechanism 325B can be omitted without departing from the scope of the present disclosure.

The exposure control mechanism 325A of the control mechanisms 320 can obtain an exposure setting. In some cases, the exposure control mechanism 325A stores the exposure setting in a memory register. Based on this exposure setting, the exposure control mechanism 325A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 330 (e.g., ISO speed or film speed), analog gain applied by the image sensor 330, or any combination thereof. The exposure setting may be referred to as an image capture setting and/or an image processing setting.

The zoom control mechanism 325C of the control mechanisms 320 can obtain a zoom setting. In some examples, the zoom control mechanism 325C stores the zoom setting in a memory register. Based on the zoom setting, the zoom control mechanism 325C can control a focal length of an assembly of lens elements (lens assembly) that includes the lens 315 and one or more additional lenses. For example, the zoom control mechanism 325C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 315 in some cases) that receives the light from the scene 310 first, with the light then passing through an afocal zoom system between the focusing lens (e.g., lens 315) and the image sensor 330 before the light reaches the image sensor 330. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 325C moves one or more of the lenses in the afocal zoom system, such as the negative lens and one or both of the positive lenses. In some cases, zoom control mechanism 325C can control the zoom by capturing an image from an image sensor of a plurality of image sensors (e.g., including image sensor 330) with a zoom corresponding to the zoom setting. For example, image capture and processing system 300 can include a wide angle image sensor with a relatively low zoom and a telephoto image sensor with a greater zoom. In some cases, based on the selected zoom setting, the zoom control mechanism 325C can capture images from a corresponding sensor.

The image sensor 330 includes one or more arrays of photodiodes or other photosensitive elements. Each photodiode measures an amount of light that eventually corresponds to a particular pixel in the image produced by the image sensor 330. In some cases, different photodiodes may be covered by different filters. In some cases, different photodiodes can be covered in color filters, and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter

Returning to FIG. 3, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 330) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 330 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 330 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 320 may be included instead or additionally in the image sensor 330. The image sensor 330 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

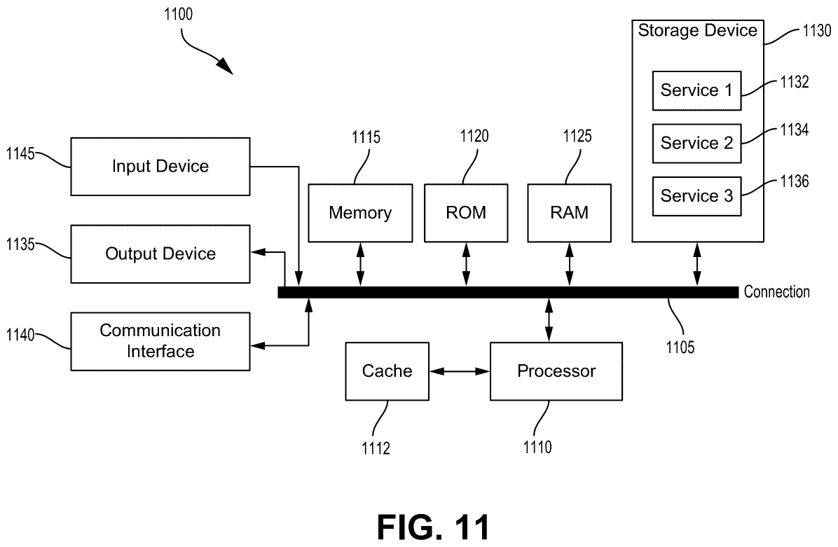

The image processor 350 may include one or more processors, such as one or more image signal processors (ISPs) (including ISP 354), one or more host processors (including host processor 352), and/or one or more of any other type of processor 1110 discussed with respect to the computing system 1100 of FIG. 11. The host processor 352 can be a digital signal processor (DSP) and/or other type of processor. In some implementations, the image processor 350 is a single integrated circuit or chip (e.g., referred to as a system-on-chip or SoC) that includes the host processor 352 and the ISP 354. In some cases, the chip can also include one or more input/output ports (e.g., input/output (I/O) ports 356), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 356 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 352 can communicate with the image sensor 330 using an I2C port, and the ISP 354 can communicate with the image sensor 330 using an MIPI port.

The image processor 350 may perform a number of tasks, such as pre-compensation of image distortion, de-mosaicing, color space conversion, image frame downsampling, pixel interpolation, automatic exposure (AE) control, automatic gain control (AGC), CDAF, PDAF, automatic white balance, merging of images to form an HDR image, image recognition, object recognition, feature recognition, receipt of inputs, managing outputs, managing memory, or some combination thereof. The image processor 350 may store images and/or processed images in random access memory (RAM) 340/1125, read-only memory (ROM) 345/1120, a cache, a memory unit, another storage device, or some combination thereof.

Various input/output (I/O) devices 360 may be connected to the image processor 350. The I/O devices 360 can include a display screen, a keyboard, a keypad, a touchscreen, a trackpad, a touch-sensitive surface, a printer, any other output devices 1135, any other input devices 1145, or some combination thereof. In some cases, a caption may be input into the image processing device 305B through a physical keyboard or keypad of the I/O devices 360, or through a virtual keyboard or keypad of a touchscreen of the I/O devices 360. The I/O 360 may include one or more ports, jacks, or other connectors that enable a wired connection between the image capture and processing system 300 and one or more peripheral devices, over which the image capture and processing system 300 may receive data from the one or more peripheral device and/or transmit data to the one or more peripheral devices. The I/O 360 may include one or more wireless transceivers that enable a wireless connection between the image capture and processing system 300 and one or more peripheral devices, over which the image capture and processing system 300 may receive data from the one or more peripheral device and/or transmit data to the one or more peripheral devices. The peripheral devices may include any of the previously-discussed types of I/O devices 360 and may themselves be considered I/O devices 360 once they are coupled to the ports, jacks, wireless transceivers, or other wired and/or wireless connectors.

In some cases, the image capture and processing system 300 may be a single device. In some cases, the image capture and processing system 300 may be two or more separate devices, including an image capture device 305A (e.g., a camera) and an image processing device 305B (e.g., a computing device coupled to the camera). In some implementations, the image capture device 305A and the image processing device 305B may be coupled together, for example via one or more wires, cables, or other electrical connectors, and/or wirelessly via one or more wireless transceivers. In some implementations, the image capture device 305A and the image processing device 305B may be disconnected from one another.

As shown in FIG. 3, a vertical dashed line divides the image capture and processing system 300 of FIG. 3 into two portions that represent the image capture device 305A and the image processing device 305B, respectively. The image capture device 305A includes the lens 315, control mechanisms 320, and the image sensor 330. The image processing device 305B includes the image processor 350 (including the ISP 354 and the host processor 352), the RAM 340, the ROM 345, and the I/O 360. In some cases, certain components illustrated in the image processing device 305B, such as the ISP 354 and/or the host processor 352, may be included in the image capture device 305A. In some examples, the image processing device 305B may be configured to process images from multiple image capture devices 305A.

For example, two or more image capture devices 305A of a multiple camera system (e.g., multiple camera system 257 of FIG. 2, multiple camera system 400 of FIG. 4A, multiple camera system 450 of FIG. 4B) may output images to a shared image processing device 305B. In some cases, each image capture device 305A of a multiple camera system can be associated with a separate image processor 350, a separate ISP 354 and/or a separate host processor 352 for processing captured images. In some cases, two or more image capture devices can be associated with a shared image processor 350, a shared ISP 354 and/or a shared host processor 352.

The image capture and processing system 300 can include an electronic device, such as a vehicle, a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 300 can include one or more wireless transceivers for wireless communications, such as cellular network communications, 1002.11 wi-fi communications, wireless local area network (WLAN) communications, or some combination thereof. In some implementations, the image capture device 305A and the image processing device 305B can be different devices. For instance, the image capture device 305A can include a camera device and the image processing device 305B can include a computing device, such as a mobile handset, a desktop computer, or other computing device.

While the image capture and processing system 300 is shown to include certain components, one of ordinary skill will appreciate that the image capture and processing system 300 can include more or fewer components than those shown in FIG. 3. In some cases, the image capture and processing system 300 can include software, hardware, or one or more combinations of software and hardware. For example, in some implementations, the components of the image capture and processing system 300 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 300.

Since a tracking vehicle (e.g., tracking vehicle 102 of FIG. 1, vehicle 401 of FIG. 4A) may have sensors (e.g., cameras) mounted at various different locations on itself, the different sensors can each have a different FOV. Since the different sensors have different FOVs, the sensors may obtain images of an object (e.g., a target vehicle) from different perspectives.

FIG. 4A shows images 430, 432, 434, 436, 438 showing images of a scene captured from different perspectives. In particular, FIG. 4A is a diagram illustrating an example of a multiple camera system 400 of a tracking vehicle 401 (e.g., an autonomous vehicle). Each of the different cameras can have a different FOV 402a, 402b, 402c, 404a, 404b, 406a, 406b, 408.

In the example of FIG. 4A, the FOVs 402a, 402b, and 402c can correspond to forward facing cameras with different FOVs (e.g., ultra-wide, wide, and narrow). FOVs 404a and 404b can correspond to forward facing side cameras, FOVs 406a and 406b can correspond to rear facing side cameras, and FOV 408 can correspond to a rear facing camera.

Since each camera has a different FOV 402a, 402b, 402c, 404a, 404b, 406a, 406b, 408, each camera can obtain an image of different scenes (e.g., portions of the environment around the vehicle 401). The geometry of the different FOVs 402a, 402b, 402c, 404a, 404b, 406a, 406b, 408 allows for the cameras of the multiple camera system 400 to observe different aspects of the environment in the images 430, 432, 434, 436, 438. In some cases, the different FOVs 402a, 402b, 402c, 404a, 404b, 406a, 406b, 408 can allow for a 360-degree FOV capture of the environment around the vehicle 401. In each of the images 430, 432, 434, 436, 438, a corresponding region of interest 440, 442, 444, 446, 448 is highlighted. In some cases, portions of the images 430, 432, 434, 436, 438 outside of the regions of interest 440, 442, 444, 446, 448 may provide little value to, for example, an object detection and tracking system that processes images captured by the multiple camera system 400 of FIG. 4A. As illustrated, a significant portion of the less valuable portions of the images is captured near the edges of the images 430, 432, 434, 436, 438.

The example multiple camera system 400 of FIG. 4A illustrates two side facing cameras for each side of the vehicle 401. For example, forward facing side camera with FOV 404a and rear facing side camera with FOV 406a can capture a left side of the environment around vehicle 401. Similarly, forward facing side camera with FOV 404b and rear facing side camera with FOV 406b can capture a right side of the environment around vehicle 401. In some cases, each additional camera included in the multiple camera system 400 can consume additional power and/or computational resources (e.g., computing resources of the multiple camera system 400, the vehicle computing system 250, the computing system 1100, or the like).

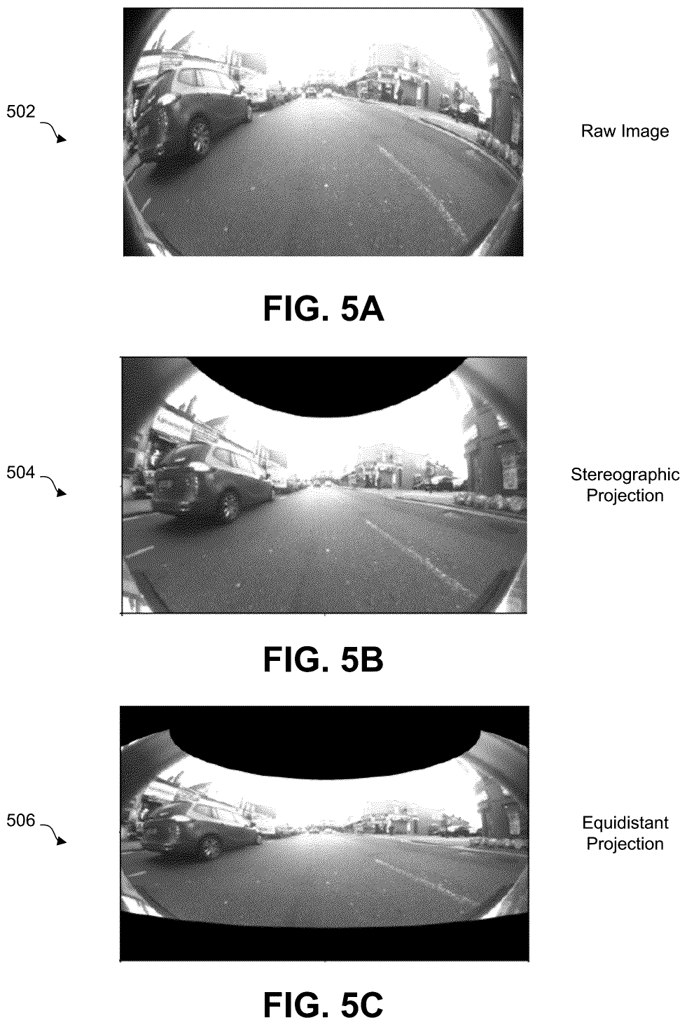

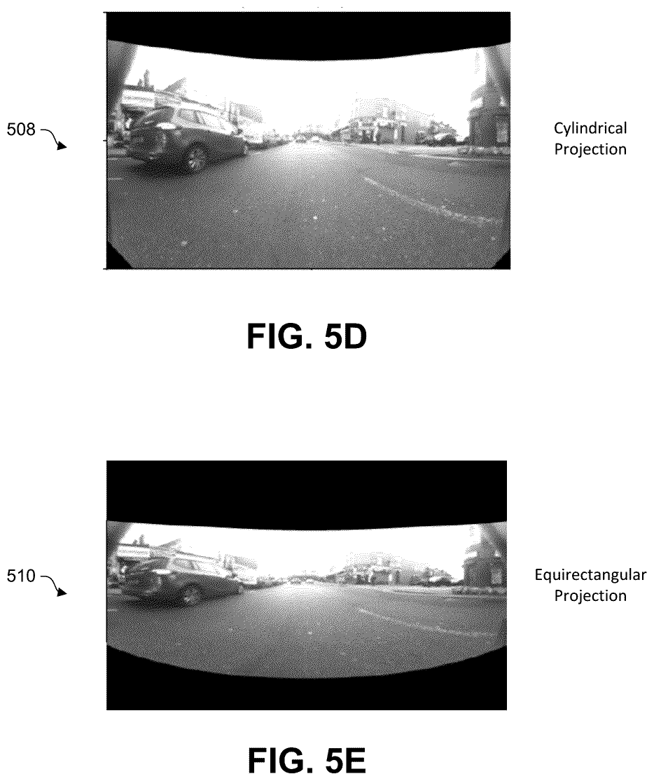

FIG. 4B illustrates an additional multiple camera system 450 that can include a lens system (e.g., lens system 700 of FIG. 7A and FIG. 7B) in accordance with the systems and techniques described herein. For the purposes of clarity, the FOVs 402a, 402b, 402c, and 408 corresponding to front facing cameras and rear facing cameras of FIG. 4A are omitted from FIG. 4B. However, it should be understood that the multiple camera system 450 of FIG. 4B can include one or more of the cameras corresponding to FOVs 402a, 402b, 402c, and/or 408. In the multiple camera system 450 of FIG. 4B, the forward facing side camera with FOV 404a and rear facing side camera with FOV 406a of FIG. 4A are replaced by a single side facing camera with FOV 460a for the left side of vehicle 403. Similarly, the forward facing side camera with FOV 404b and rear facing side camera with FOV 406b of FIG. 4A are replaced by a single side facing camera with FOV 460b for the right side of vehicle 403. As discussed in more detail below with respect to FIG. 7A and FIG. 7B, the lens system 700 can provide optical compression of the images captured by the side facing cameras such that an image sensor with an aspect ratio equal to the aspect ratio of image sensors utilized by any of the forward and/or rear facing side cameras of FIG. 4A can capture the full 180-degree horizontal FOV of FOVs 460a and 460b. In addition, the lens system 700 of FIG. 7A and FIG. 7B can produce an image with the optical distortion characteristic illustrated in image 470. The optical distortion characteristic illustrated in image 470 corresponds to an equirectangular projection 510 as illustrated in FIG. 5E. In some cases, the lens system 700 can produce any desired optical distortion characteristic, such as the stereographic projection 504 shown in FIG. 5B, the equidistant projection 506 shown in FIG. 5C, or the cylindrical projection 508 shown in FIG. 5D.

FIG. 5A illustrates a distorted raw image 502 (e.g., an image captured by a camera of the multiple camera system 400. In the illustrated example, the distorted raw image 502 includes optical distortion. In some cases, image pre-processing (e.g., in the form of digital image manipulation) can be used to perform software-based distortion compensation. In one illustrative example, warping the distorted image with a projection technique (e.g., stereographic projection, equidistant project, equirectangular project, cylindrical projection, or the like) can compensate for the distortion. However, software-based compensation for distortion can be difficult and computationally expensive to perform. Moreover, software-based compensation can, in some cases, rely on approximations and/or models that may not be applicable in all cases, and can end up warping the image inaccurately or incompletely. In some aspects, the resulting image with the compensation applied may still retain some distortion, may end up distorted in an different manner to the original image due to incorrect and/or incomplete distortion compensation, and/or may include other visual artifacts.

FIGS. 5B through 5E illustrate example projections 504, 506, 508, 510 of the raw image. The example image of FIG. 5B illustrates an examples stereographic projection 504 of the distorted raw image 502. The stereographic projection 504 can include projecting the two-dimensional (2D) raw image 502 onto the surface of a 3D sphere at a specified distance from the image in a projection space. FIG. 5C illustrates an example of an equidistant projection 506. As illustrated, an equidistant projection 506 can preserve a distance and direction of objects from the center of the raw image 502. FIG. 5D illustrates a cylindrical projection 508, in which the 2D raw image 502 can be projected onto the surface of a 3D cylinder. FIG. 5E illustrates an equirectangular projection 510 which can be a hybrid of the cylindrical project 508 and the equidistant project 506.

Returning to FIG. 2, in some cases, the vehicle computing system 250 can include and/or be included in the multiple camera system 400 of FIG. 4A. In some examples, the vehicle computing system 250 can include and/or be included in the multiple camera system 450 of FIG. 4B.

In some examples, the vehicle computing system 250 of FIG. 2 can include the image capture and processing system 300, the image capture device 305A, the image processing device 305B, or a combination thereof. In some examples, the multiple camera system 400 of FIG. 4A can include the image capture and processing system 300, the image capture device 305A, the image processing device 305B, or a combination thereof. In some examples, the multiple camera system 450 of FIG. 4B can include the image capture and processing system 300, the image capture device 305A, the image processing device 305B, or a combination thereof.

FIG. 7A illustrates a cross-sectional view and FIG. 7B illustrates a perspective view of an example lens system 700 that can be included in a wide field of view camera (e.g., side facing cameras with FOVs 460a, 460b of FIG. 4B). A In the illustrated example, the lens system 700 includes multiple optical elements, 702, 704, 706, 708, 730. In the illustrated example, an optical axis 705 passes through the optical elements 702, 704, 706, 708, 730 of the lens system. In some cases, the optical elements 702, 704, 706, 708, 730 can be aligned relative to the optical axis 705. In some aspects, optical properties of the optical elements 702, 704, 706, 708, 730 can collectively contribute to the overall optical properties of the lens system 700.

Optical properties of the optical elements 702, 704, 706, 708, 730 can include curvature (e.g., biconvex, plano-convex, positive meniscus, negative meniscus, plano-concave, biconcave, convex-concave, concave-convex, planar), focal length, refractive index, radius of curvature, focus, thickness (e.g., distance along the optical axis 705 between the two surface vertices of a lens), optical power, magnification, zoom, spherical aberration, coma, chromatic aberration, field curvature, barrel distortion, pincushion distortion, other radial distortion, other distortion, astigmatism, other aberrations, aperture size, aperture shape, aperture diffraction, achromat, special surfaces and/or lens arrangements (e.g., compound lensing, aspherical lensing, Fresnel lensing, lenticular lensing, and/or axicon lensing), bifocal lensing, gradient index, diffraction, optical coatings, anti-fogging treatment, polarization, any other optical properties, and/or combinations thereof.

In some cases, an aspherical optical element 702 can be designed to refract the light to compensate for distortions produced by one or more of the optical elements 704, 706, 708, 730. For example, unlike a spherical optical element which can have a surface with a uniform radius of curvature, the radius of curvature across the front and/or back surface of the aspherical optical element 702 can have varying radius of curvature. In some cases, the variations in radius of curvature of the optical elements 702 can redirect light rays incident on the lens system 700 from different angles of incidence such that the path traveled by each ray is positioned at a desired position in an image formed at the image plane. As illustrated in FIG. 7A, the image sensor 710 can be positioned at the image plane. In some cases, the aspherical optical element 702 can be designed to compensate for the distortions produced by one or more of the optical elements 704, 706, 708, 730 to produce an optical distortion characteristic (e.g., an equirectangular projection, a cylindrical projection, or any other suitable projection) for the lens system 700.

In some cases, the lens system 700 can be configured to produce optical compression (e.g., magnification) along a first image axis 715 (e.g., a horizontal image axis). In FIG. 7A, the first image axis 715 is depicted as the tail of a vector pointing into the page corresponding to the Y-axis of the cartesian coordinate system. In some cases, at least one or more of the first cylindrical optical element 704 or the second cylindrical optical element 708 can provide different magnification along the first image axis 715 than the magnification provided along the second image axis 720. In one illustrative example, the magnification along the horizontal axis (e.g., the first image axis 715) can be half of the magnification along the vertical axis. (e.g., the second image axis 720). In some cases, a single cylindrical optical element may not be able to provide a focused image along both the first image axis 715 and the second image axis 720. For example, the image produced by a single cylindrical optical element (e.g., either optical element 704 or optical element 708 may not focus to a spot along the magnified axis (e.g., the first axis). In some cases, the second cylindrical optical element 708 can focus the light passing through the first cylindrical optical element. In some examples, at least one of the first or second optical elements can contribute to the difference in magnification along the first image axis 715 and the second image axis 720. As illustrated by FIG. 7A. a combination of two cylindrical optical elements 704, 708 can produce a focused image having non-symmetrical magnification while still being able to produce a focused image at the image plane.

A potential disadvantage of the aspherical optical element 702, first cylindrical optical element 704, and/or second cylindrical optical element 708 can be that the amount of light received at the image sensor 710 may be reduced relative to a lens system utilizing different optical elements (e.g., fewer cylindrical optical elements). In the illustrated example of FIG. 7A, the aperture 706 can be configured to compensate for the light loss. In one illustrative example, the aperture 706 can be configured in an oval shape (e.g., in contrast to a circular aperture used in many existing lens systems). In another illustrative example, the aperture 706 can be configured as an oversized circular aperture (e.g., regular to a smaller circular aperture used in many existing lens systems). In one illustrative example, the aperture 706 can be configured such that the entrance pupil area is equal to the entrance pupil area of a lens solution without cylindrical elements. In some cases, an upper limit for the size of the aperture 706 can be determined based on one or more image quality requirements of a camera system incorporating the lens system.

FIG. 7B illustrates a 3D perspective view of the lens system 700. As illustrated in FIG. 7B, the cartesian coordinate system defined by the X-axis, Y-axis, and Z-axis is consistent with the coordinate system shown in FIG. 7A. The lens system 700 of FIG. 7B can correspond to the lens system 700 of FIG. 7A, although small differences may be evident in the sizes, shapes, and/or spacings of the optical elements 702. 704, 706, 708, and 730. FIG. 7B includes an image sensor 710 at the focal point of the lens system 700 that can correspond to the 710 of FIG. 7A. In FIG. 7B, the optical elements 730 are unlabeled to provide visual clarity. FIG. 7B also provides a view of the optical axis 705, first image axis 715, and second image axis 720 intersecting at a point behind the image sensor 710. It should be understood that the image plane (which can be defined by the first and second image axes 715, 720) may actually be positioned at a front surface of the image sensor 710 as illustrated in FIG. 7A. The depiction of the first and second image axes 715, 720 behind the image sensor 710 is provided so that the relationship between the optical axis 705, first image axis 715 and second image axis 720 can be more clearly visualized.

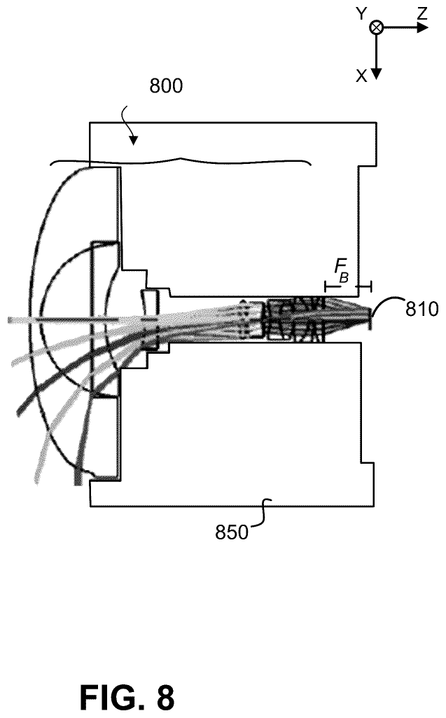

FIG. 8 illustrates an example of a lens holder 850 for aligning a lens system 800 with an image sensor 810. As illustrated, the lens system 800 can be similar to and perform similar functions to the lens system 700 of FIG. 7A and FIG. 7B. The image sensor 810 can be similar to and perform similar functions to the image sensor 710 of FIG. 7A and FIG. 7B. As illustrated in FIG. 8, the cartesian coordinate system defined by the X-axis, Y-axis, and Z-axis is consistent with the coordinate system shown in FIG. 7A and FIG. 7B. In some implementations, the lens holder 850 and/or the lens system 800 can include one or more mechanical features that can be used to automatically align the rotationally sensitive components of the lens system 800 in a specified orientation relative to the lens holder 850. For example, the one or more mechanical features can be used when assembling rotationally sensitive components of a camera (e.g., by mounting the lens holder to a camera body or image sensor mount) to assure proper orientation between the lens system 800 and the image sensor 810. In some cases, the aligned lens holder 850/lens system 800 can be used to align a first axis of the lens system to a corresponding photosensor axis (e.g., a horizontal axis) of the image sensor 810. For example, the alignment provided by the mechanical features can be used to align the aspherical optical element 702, cylindrical optical element 704, aperture 706, and cylindrical optical element 708 of FIG. 7A and FIG. 7B relative to the image sensor 810. In some cases, the lens holder 850 can also be configured to reliably position the image sensor 810 at the back focal length F_{B} of the lens system 800. Accordingly, the lens holder 850 can be used to ensure proper alignment and/or focus of the lens system 800 to achieve expected performance of a camera system incorporating the lens system 800.

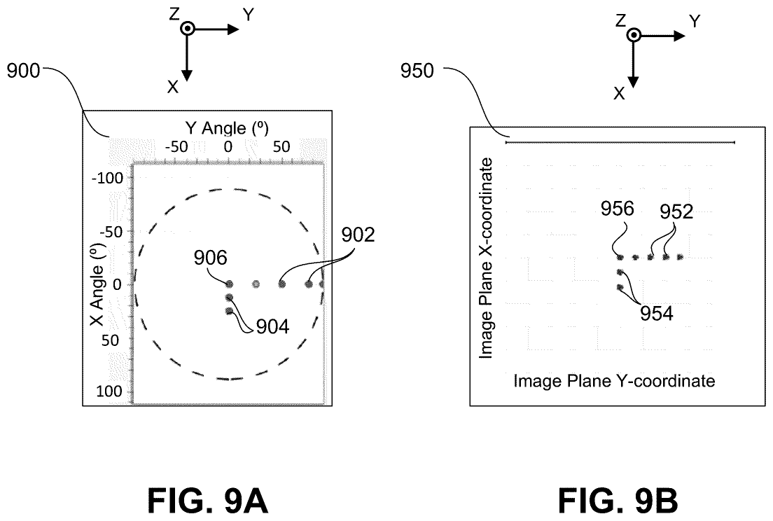

FIG. 9A and FIG. 9B illustrate performance of a simulated lens system designed according to the systems and techniques described herein. For example, the simulated lens system can correspond to lens system 700 of FIG. 7A and FIG. 7B. As illustrated in FIG. 9A and FIG. 9B, a cartesian coordinate system defined by an X-axis, Y-axis, and Z-axis of the is consistent with the cartesian coordinate system illustrated in FIG. 7A. 7B, and 8. FIG. 9A illustrates a plot 900 depicting horizontally spaced angular field positions 902 and vertically spaced angular field positions 904. Central angular field position 906 is common to both the horizontally spaced angular field positions 902 and the 904. In the plot 900, the horizontal axis corresponds to a viewing angle along the Y-axis of the cartesian coordinate system and the vertical image axis corresponds to a viewing angle along the X-axis of the cartesian coordinate system. For the purposes of illustration, each of the individual angular field positions 902, 904, 906 can represent an image of an object in a scene produced by the lens system 700 of FIG. 7A and FIG. 7B. As illustrated, the horizontally spaced angular field positions 902 are evenly spaced among one another and are also evenly spaced with the central angular field position 906. Similarly, the vertically spaced angular field positions 904 are evenly spaced among one another and are also evenly spaced with the central angular field position 906. In the example of FIG. 9A, the horizontal spacing between horizontally spaced angular field positions 902 is exactly double the vertical spacing between vertically spaced angular field positions 904.

FIG. 9B illustrates an example plot 950 of an image space corresponding to the objects (e.g., angular field positions 902, 904, 906) produced by the lens system 700 of FIG. 7A and FIG. 7B. For the purposes of illustration, the positions of the angular field positions 952, 954, 956 can be understood to represent relative location of the light corresponding to the objects (e.g., angular field positions 902, 904, 906) at the image plane. For example, the locations of the angular field positions 952, 954, 956 could be indicative of which photosensor in a photosensor array (e.g., a photosensor array of image sensor 710) would detect the light from a corresponding object (e.g., represented by angular field positions 902, 904, 906). As illustrated in FIG. 9B, the horizontal spacing between horizontally spaced angular field positions 952 is equal to the vertical spacing between vertically spaced angular field positions 954 and the central angular field position 956 is equally spaced from the nearest horizontally spaced angular field position 952 and the nearest vertically spaced angular field position 954.

As illustrated, the image demonstrates a horizontal compression (e.g., magnification) along the horizontal axis (e.g., the Y-axis) of the image. In the illustrated example, the horizontal axis magnification can be equal to (or approximately equal to) half of the vertical axis magnification. FIG. 9B also illustrates that the simulated lens system provides uniform magnification between 0 and 90 degrees viewing angle in the Y-axis direction. FIG. 9B also illustrates uniform magnification between 0 and 45 degrees in the X-axis direction. In some cases, the uniform magnification can correspond to a cylindrical and/or equirectangular optical distortion characteristic for the simulated lens system. Accordingly, the plots 900 and 950 illustrate that a lens system according to the systems and techniques herein can provide a first magnification along a first axis (e.g., the horizontal axis) and a second magnification, different from the first magnification along a second axis (e.g., the vertical axis). FIG. 9A and FIG. 9B also illustrate that the aspherical optical element 702 of the lens system 700 can be used produce a desired optical distortion characteristic for the lens systems 700. In one illustrative example, the aspherical optical element 702 can be configured to produce a linear relationship between angular field positions in an object space and coordinates in a coordinate system of an image plane. For example, replacing the aspherical optical element 702 with a spherical optical clement with the remaining optical elements 704, 706, 708, 730 remaining unchanged would result in a non-uniform spacing of the angular field positions 952, 954, 956. In one illustrative example, the spacing between angular field positions at the image plane may become smaller as the view angle in either the X-axis direction or the Y-axis direction increases.

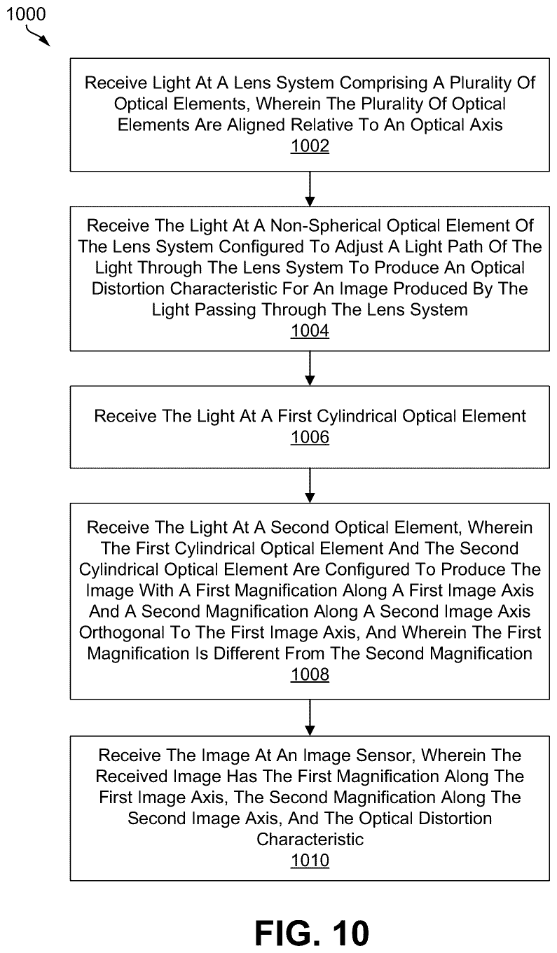

FIG. 10 is a flow diagram illustrating an example of a process 1000 for performing point map registration, according to some aspects of the disclosed technology. In some implementations, the process 1000 can include, at step 1002. receiving light at a lens system (e.g., lens system 700 of FIG. 7A and FIG. 7B) including a plurality of optical elements (e.g. optical elements 702, 704, 706, 708, 730 of FIG. 7A and FIG. 7B). In some cases, the plurality of optical elements is aligned relative to an optical axis (e.g., optical axis 705 of FIG. 7A and FIG. 7B).

At step 1004, the process 1000 includes receiving the light at an aspherical optical element (e.g., aspherical optical element 702 of FIG. 7A and FIG. 7B) of the lens system (e.g., lens system 700 of FIG. 7A and FIG. 7B) configured to adjust a light path of the light through the lens system to produce an optical distortion characteristic (e.g., equirectangular projection 510, cylindrical projection 508) for an image produced by the light passing through the lens system. In some cases, the aspherical optical element includes an aspherical lens. In some implementations, the optical distortion characteristic is configured to generate a linear relationship between angular field positions of objects in an object space and coordinates in a coordinate system of an image plane (e.g., as illustrating in FIG. 9A and FIG. 9B). In some examples, the aspherical optical element provides different aspherical profiles along the first image axis and the second image axis.

At step 1006, the process 1000 includes receiving the light at a first cylindrical optical element (e.g., first cylindrical optical element 704 of FIG. 7A and FIG. 7B).

At step 1008, the process 1000 includes receiving the light at a second cylindrical optical element (e.g., second cylindrical optical element 708 of FIG. 7A and FIG. 7B). In some examples, the first cylindrical optical element and the second cylindrical optical element are configured to produce the image with a first magnification along a first image axis (e.g., first image axis 715 of FIG. 7A and FIG. 7B) and a second magnification along a second image axis (e.g., second image axis 720 of FIG. 7A and FIG. 7B) orthogonal to the first image axis. In some aspects, the first magnification is different from the second magnification. In some cases, the first magnification is greater than the second magnification. In some cases, the first image axis is a vertical image axis and the second image axis is a horizontal image axis.

At step 1010, the process 1000 includes receiving the image at an image sensor (e.g., image sensor 710 of FIG. 7A and FIG. 7B). In some examples, the received image has the first magnification along the first image axis, the second magnification along the second image axis, and the optical distortion characteristic. In some aspects, the image sensor receives the image at an array of photosensors of the image sensor; the array of photosensors is a rectangular array of photosensors. In some cases, a first axis of the rectangular array of photosensors is aligned with the first image axis and a second axis of the rectangular array of photosensors is aligned with the second image axis. In some examples, the first axis of the rectangular array corresponds to a first number of photosensors, the second axis of the rectangular array corresponds to a second number of photosensors, and the first number of photosensors is greater than the second number of photosensors. In some cases, the first axis of the rectangular array corresponds to a first field of view having a first field angle; the second axis of the rectangular array corresponds to a second field of view having a second field angle, and a ratio between a first field angle and the second field angle is greater than a ratio between the first number of photosensors and the second number of photosensors.

In some examples, the processes described herein (e.g., process 1000 and/or other process described herein) may be performed by a computing device or apparatus (e.g., a vehicle computer system). In one example, the process 1000 can be performed by vehicle computing system 250 shown in FIG. 2. In another example, the process 1000 can be performed by a computing device with the computing system 1100 shown in FIG. 11. For instance, a vehicle with the computing architecture shown in FIG. 11 can include the components of vehicle computing system 250 shown in FIG. 2 and can implement the operations of process 1000 shown in FIG. 10.

The process 1000 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1000 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the WiFi (802.11x) standards, data according to the Bluetooth™0 standard, data according to the Internet Protocol (IP) standard, and/or other types of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

FIG. 11 is a diagram illustrating an example of a system for implementing certain aspects of the present technology. In particular, FIG. 11 illustrates an example of computing system 1100, which can be for example any computing device making up internal computing system, a remote computing system, a camera, or any component thereof in which the components of the system are in communication with each other using connection 1105. Connection 1105 can be a physical connection using a bus, or a direct connection into processor 1110, such as in a chipset architecture. Connection 1105 can also be a virtual connection, networked connection, or logical connection.

In some embodiments, computing system 1100 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1100 includes at least one processing unit (CPU or processor) 1110 and connection 1105 that couples various system components including system memory 1115, such as read-only memory (ROM) 1120 and random-access memory (RAM) 1125 to processor 1110. Computing system 1100 can include a cache 1112 of high-speed memory connected directly with, in close proximity to, or integrated as part of processor 1110.

Processor 1110 can include any general-purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms. In some instances, multimodal systems can enable a user to provide multiple types of input/output to communicate with computing system 1100. Computing system 1100 can include communications interface 1140, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1130 can include software services, servers, services, etc., that when the code that defines such software is executed by the processor 1110, it causes the system to perform a function. In some embodiments, a hardware service that performs a particular function can include the software component stored in a computer-readable medium in connection with the necessary hardware components, such as processor 1110, connection 1105, output device 1135, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections.

Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing. message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative aspects of the disclosure include the following:

Aspect 1. A lens system comprising: a plurality of optical elements aligned relative to an optical axis, wherein the plurality of optical elements comprises: an aspherical optical element configured to produce an optical distortion characteristic for light passing through the plurality of optical elements; a first cylindrical optical element; and a second cylindrical optical element, wherein the first cylindrical optical element and the second cylindrical optical element are configured to produce an image with a first magnification along a first image axis and a second magnification along a second image axis orthogonal to the first image axis, and wherein the first magnification is different from the second magnification.

Aspect 2. The lens system of Aspect 1, wherein the first image axis comprises a horizontal image axis and the second image axis comprises a vertical image axis.

Aspect 3 The lens system of any of Aspects 1 to 2, wherein the first magnification is less than the second magnification.

Aspect 4. The lens system of any of Aspects 1 to 3, wherein the first magnification is at most half the second magnification.

Aspect 5. The lens system of any of Aspects 1 to 4, wherein the aspherical optical element comprises an aspherical lens.

Aspect 6. The lens system of any of Aspects 1 to 5, wherein the aspherical optical element provides cylindrical power.

Aspect 7. The lens system of any of Aspects 1 to 6, wherein the aspherical optical element provides different aspherical profiles along the first image axis and the second image axis.

Aspect 8. The lens system of any of Aspects 1 to 7, wherein the plurality of optical elements is configured to generate a focused image of a scene at an image plane.

Aspect 9. The lens system of any of Aspects 1 to 8, wherein the optical distortion characteristic is configured to generate a first linear relationship between horizontal angular field positions of objects in an object space and image coordinates along the first image axis and a second linear relationship between vertical angular field positions in the object space and image coordinates along the second image axis .

Aspect 10. The lens system of any of Aspects 1 to 9, further comprising an aperture, wherein the aperture is non-circular.

Aspect 11. The lens system of any of Aspects 1 to 10, further comprising an aperture, wherein: the aperture is disposed between the first cylindrical optical element and an image plane of the lens system; and the second cylindrical optical element is disposed between the aperture and the image plane of the lens system.

Aspect 12. The lens system of any of Aspects 1 to 11, further comprising a unibody lens holder, wherein the plurality of optical elements is aligned relative to at least one alignment feature of the unibody lens holder.

Aspect 13. The lens system of any of Aspects 1 to 12, wherein the at least one alignment feature is configured to mate with a mounting fixture, wherein the lens system mated with the mounting fixture provides a predetermined rotational alignment of the first image axis and the second image axis.

Aspect 14. A camera system comprising: a lens system comprising: a plurality of optical elements aligned relative to an optical axis, wherein the plurality of optical elements includes: an aspherical optical element configured to produce an optical distortion characteristic for light passing through the plurality of optical elements; a first cylindrical optical element; a second cylindrical optical element, wherein the first cylindrical optical element and the second cylindrical optical element are configured to produce an image with a first magnification along a first image axis and a second magnification along a second image axis orthogonal to the first image axis, and wherein the first magnification is different from the second magnification; and an image sensor, wherein the optical axis intersects with an array of photosensors of the image sensor.

Aspect 15. The camera system of Aspect 14, wherein the first image axis is a horizontal image axis and the second image axis is a vertical image axis.

Aspect 16. The camera system of any of Aspects 14 to 15, wherein the array of photosensors is a rectangular array of photosensors, wherein a first axis of the rectangular array of photosensors is aligned with the first image axis and a second axis of the rectangular array of photosensors is aligned with the second image axis.

Aspect 17. The camera system of any of Aspects 14 to 16, wherein: the first axis of the rectangular array corresponds to a first number of photosensors; the second axis of the rectangular array corresponds to a second number of photosensors; and the first number of photosensors is greater than the second number of photosensors.

Aspect 18. The camera system of any of Aspects 14 to 18, wherein: the first axis of the rectangular array corresponds to a first angle of view; the second axis of the rectangular array corresponds to a second angle of view; and a ratio between the first angle of view and the second angle of view is greater than a ratio between the first number of photosensors and the second number of photosensors.

Aspect 19. The camera system of any of Aspects 14 to 18, further comprising a lens mount and a lens holder, wherein at least one or more of the lens holder or the lens mount includes alignment features configured to align the first axis of the image sensor with the first image axis and to align the second axis of the image sensor with the second image axis.

Aspect 20. The camera system of any of Aspects 14 to 19, wherein the camera system is coupled to a vehicle.

Aspect 21. The camera system of any of Aspects 14 to 20, wherein a sensing system of the vehicle comprises a plurality of sensors including the camera system, wherein the camera system and one or more additional sensors of the plurality of sensors capture information associated with an environment external to the vehicle.

Aspect 22. A method of optical detection comprising: receiving light at a lens system comprising a plurality of optical elements, wherein the plurality of optical elements is aligned relative to an optical axis; receiving the light at an aspherical optical element of the lens system configured to adjust a light path of the light through the lens system to produce an optical distortion characteristic for an image produced by the light passing through the lens system; receiving the light at a first cylindrical optical element; receiving the light at a second cylindrical optical element, wherein the first cylindrical optical element and the second cylindrical optical element are configured to produce the image with a first magnification along a first image axis and a second magnification along a second image axis orthogonal to the first image axis, and wherein the first magnification is different from the second magnification; and receiving the image at an image sensor, wherein the received image has the first magnification along the first image axis, the second magnification along the second image axis, and the optical distortion characteristic.

Aspect 23. The method of Aspect 22, wherein the aspherical optical element comprises an aspherical lens.

Aspect 24. The method of any of Aspects 22 to 23, wherein the first image axis comprises a horizontal image axis and the second image axis comprises a vertical image axis.

Aspect 25. The method of any of Aspects 22 to 24, wherein the first magnification is less than the second magnification.

Aspect 26. The method of any of Aspects 22 to 25, wherein: the image sensor receives the image at an array of photosensors of the image sensor; the array of photosensors is a rectangular array of photosensors; a first axis of the rectangular array of photosensors is aligned with the first image axis; and a second axis of the rectangular array of photosensors is aligned with the second image axis.

Aspect 27. The method of any of Aspects 22 to 26, wherein: the first axis of the rectangular array corresponds to a first number of photosensors; the second axis of the rectangular array corresponds to a second number of photosensors; and the first number of photosensors is greater than the second number of photosensors.

Aspect 28. The method of any of Aspects 22 to 27, wherein: the first axis of the rectangular array corresponds to a first angle of view; the second axis of the rectangular array corresponds to a second angle of view; and a ratio between the first angle of view and the second angle of view is greater than a ratio between the first number of photosensors and the second number of photosensors.

Aspect 29. The method of any of Aspects 22 to 28, wherein the optical distortion characteristic is configured to generate a first linear relationship between horizontal angular field positions of objects in an object space and image coordinates along the first image axis and a second linear relationship between vertical angular field positions in the object space and image coordinates along the second image axis.

Aspect 30. The method of any of Aspects 22 to 29, wherein the aspherical optical element provides different aspherical profiles along the first image axis and the second image axis.

Aspect 31: A non-transitory computer-readable storage medium having stored thereon instructions which, when executed by one or more processors, cause the one or more processors to perform any of the operations of aspects 1 to 30.

Aspect 32: An apparatus comprising means for performing any of the operations of aspects 1 to 30.

What is claimed is:

1. A lens system comprising:
a plurality of optical elements aligned relative to an optical axis, wherein the plurality of optical elements comprises:
an aspherical optical element configured to produce an optical distortion characteristic for light passing through the plurality of optical elements;
a first cylindrical optical element; and
a second cylindrical optical element, wherein the first cylindrical optical element and the second cylindrical optical element are configured to produce an image with a first magnification along a first image axis and a second magnification along a second image axis orthogonal to the first image axis, and wherein the first magnification is different from the second magnification.

2. The lens system of claim 1, wherein the first image axis comprises a horizontal image axis and the second image axis comprises a vertical image axis.

3. The lens system of claim 2, wherein the first magnification is less than the second magnification.

4. The lens system of claim 3, wherein the first magnification is at most half the second magnification.

5. The lens system of claim 1, wherein the aspherical optical element comprises an aspherical lens.

6. The lens system of claim 1, wherein the aspherical optical element provides cylindrical power.

7. The lens system of claim 1, wherein the aspherical optical element provides different aspherical profiles along the first image axis and the second image axis.

8. The lens system of claim 1, wherein the plurality of optical elements is configured to generate a focused image of a scene at an image plane.

9. The lens system of claim 1, wherein the optical distortion characteristic is configured to generate a first linear relationship between horizontal angular field positions of objects in an object space and image coordinates along the first image axis and a second linear relationship between vertical angular field positions in the object space and image coordinates along the second image axis.

10. The lens system of claim 1, further comprising an aperture, wherein the aperture is non-circular.

11. The lens system of claim 1, further comprising an aperture, wherein:
the aperture is disposed between the first cylindrical optical element and an image plane of the lens system; and
the second cylindrical optical element is disposed between the aperture and the image plane of the lens system.

12. The lens system of claim 1, further comprising a unibody lens holder, wherein the plurality of optical elements is aligned relative to at least one alignment feature of the unibody lens holder.

13. The lens system of claim 12, wherein the at least one alignment feature is configured to mate with a mounting fixture, wherein the lens system mated with the mounting fixture provides a predetermined rotational alignment of the first image axis and the second image axis.

14. A camera system comprising:
a lens system comprising:
a plurality of optical elements aligned relative to an optical axis, wherein the plurality of optical elements comprises:
an aspherical optical element configured to produce an optical distortion characteristic for light passing through the plurality of optical elements;
a first cylindrical optical element;
a second cylindrical optical element, wherein the first cylindrical optical element and the second cylindrical optical element are configured to produce an image with a first magnification along a first image axis and a second magnification along a second image axis orthogonal to the first image axis, and wherein the first magnification is different from the second magnification; and
an image sensor, wherein the optical axis intersects with an array of photosensors of the image sensor.

15. The camera system of claim 14, wherein the first image axis is a horizontal image axis and the second image axis is a vertical image axis.

16. The camera system of claim 15, wherein the array of photosensors is a rectangular array of photosensors, wherein a first axis of the rectangular array of photosensors is aligned with the first image axis and a second axis of the rectangular array of photosensors is aligned with the second image axis.

17. The camera system of claim 16, wherein:
the first axis of the rectangular array corresponds to a first number of photosensors;
the second axis of the rectangular array corresponds to a second number of photosensors; and
the first number of photosensors is greater than the second number of photosensors.

18. The camera system of claim 17, wherein:
the first axis of the rectangular array corresponds to a first angle of view;
the second axis of the rectangular array corresponds to a second angle of view; and
a ratio between the first angle of view and the second angle of view is greater than a ratio between the first number of photosensors and the second number of photosensors.

19. The camera system of claim 16, further comprising a lens mount and a lens holder, wherein at least one or more of the lens holder or the lens mount includes alignment features configured to align the first axis of the image sensor with the first image axis and to align the second axis of the image sensor with the second image axis.

20. The camera system of claim 16, wherein the plurality of optical elements, further comprises an aperture, wherein:
the aperture is disposed between the first cylindrical optical element and an image plane of the lens system; and
the second cylindrical optical element is disposed between the aperture and the image plane of the lens system.

21. The camera system of claim 20 wherein the camera system is coupled to a vehicle, wherein a sensing system of the vehicle comprises a plurality of sensors including the camera system, wherein the camera system and one or more additional sensors of the plurality of sensors capture information associated with an environment external to the vehicle.

22. A method of optical detection comprising:
receiving light at a lens system comprising a plurality of optical elements, wherein the plurality of optical elements is aligned relative to an optical axis;
receiving the light at an aspherical optical element of the lens system configured to adjust a light path of the light through the lens system to produce an optical distortion characteristic for an image produced by the light passing through the lens system;
receiving the light at a first cylindrical optical element;
receiving the light at a second cylindrical optical element, wherein the first cylindrical optical element and the second cylindrical optical element are configured to produce the image with a first magnification along a first image axis and a second magnification along a second image axis orthogonal to the first image axis, and wherein the first magnification is different from the second magnification; and
receiving the image at an image sensor, wherein the received image has the first magnification along the first image axis, the second magnification along the second image axis, and the optical distortion characteristic.

23. The method of claim 22, wherein the aspherical optical element comprises an aspherical lens.

24. The method of claim 22, wherein the first image axis comprises a horizontal image axis and the second image axis comprises a vertical image axis.

25. The method of claim 24, wherein the first magnification is less than the second magnification.

26. The method of claim 25, wherein:
the image sensor receives the image at an array of photosensors of the image sensor;
the array of photosensors is a rectangular array of photosensors;
a first axis of the rectangular array of photosensors is aligned with the first image axis; and
a second axis of the rectangular array of photosensors is aligned with the second image axis.

27. The method of claim 26, wherein:
the first axis of the rectangular array corresponds to a first number of photosensors;
the second axis of the rectangular array corresponds to a second number of photosensors; and
the first number of photosensors is greater than the second number of photosensors.

28. The method of claim 27, wherein:
the first axis of the rectangular array corresponds to a first angle of view;
the second axis of the rectangular array corresponds to a second angle of view; and
a ratio between the first angle of view and the second angle of view is greater than a ratio between the first number of photosensors and the second number of photosensors.

29. The method of claim 22, wherein the optical distortion characteristic is configured to generate a first linear relationship between horizontal angular field positions of objects in an object space and image coordinates along the first image axis and a second linear relationship between vertical angular field positions in the object space and image coordinates along the second image axis.

30. The method of claim 22, wherein the aspherical optical element provides different aspherical profiles along the first image axis and the second image axis.
